(19) United States
(12) Patent Application Publication
(10) Pub. No.: US 2006/0287970 A1
(43) Pub. Date: Dec. 21, 2006

(54) System for verification of job applicant information

(76) Inventors: David M. Chess, Mohegan Lake, NY (US); Sophia Krasikov, Katonah, NY (US); Alla Segal, Mount Kisco, NY (US)

Correspondence Address: FERENCE & ASSOCIATES, 409 BROAD STREET, PITTSBURGH, PA, 15143, US

(21) Appl. No.: 11/140,725

(22) Filed: May 31, 2005

(51) Int. Cl. G06F 17/30; G06F 7/00; G06F 17/00

(52) U.S. Cl. 707/1; 715/505; 707/100

(57) ABSTRACT

A system for automatically screening resumes and/or job/admission applications for false information as well as for specific factors that make a particular candidate non-suitable for a particular job or school. The tool can also be used to generate questions that could be asked of a specific candidate based on the information provided in the resume. Such a tool may optionally include a database preconfigured with some of the information pertinent to a specific field/group of jobs. It can also optionally include the list of well-known companies hiring candidates with specific backgrounds, the contact e-mail and the information of the skills that could be utilized by each company in a given year. The system allows for manual as well as automated updates (e.g. live update from the service provider) of the database.

### FIELD OF THE INVENTION

The present invention generally relates to arrangements and methods for providing fact-checking or verification of input forms such as resumes or job applications.

### BACKGROUND OF THE INVENTION

In job recruiting, prospective employers normally need to spend a lot of time going through a number of resumes and job applications. Some of these resumes may contain incorrect or fraudulent information. Among the prime examples of such lying in resumes are non-accredited and sometimes even non-existent universities, non-existent companies or companies the applicant never worked for, an inflated number of years of experience, and inflated skills. The Internet, offering access to an increased number of non-accredited universities (e.g., offering a PhD in 6 months) as well as globalization overall, increases the importance of the need for accurate verification of different types of information. Similar issues can come up during admission processes to colleges, universities, military schools, and military services.

Currently existing tools for automated resume processing (as found, for example, at http://www.trak-it.com/Press_Morster_Resumes.html) tend to concentrate on extracting important information from the resumes and matching specified skills with the requirements of a particular position. Utterly lacking are tools that could help verify whether the skills or other information provided on the resume or job application are actually true. Since most recruiters don't have enough time to verify the information, an unqualified employee often gets hired which results (1) in significant loss of money to the company and (2) in creating security gaps for the company, industry or even state or country.

In addition to the generic verification of information provided by a job applicant, some jobs require more stringent verification of specific types of information. For example, a hospital may want to know if there was a board action against a specific medical professional. A recruiter of a child care professional or a nursing home employee may need to verify the criminal record of a candidate. A nuclear power station or a chemical factory may need to check if a specific candidate is on a terrorist watch list.

It is thus hereby recognized that a capability to automatically verify the information provided on a resume or an application form, as well as other information about the candidate, will lead to a more efficient screening process and will result in significant savings in time and money for recruiters and/or admission committees.

Many such tasks are currently done manually with recruiters paying companies (such as cisonline.com; see CIS below) to verify individual items on a single resume such as a single person's education or police record. However, before a single item on a single resume can be verified, the resume must already be chosen, so a lot of work up to that point has already clearly been done. It is thus hereby recognized that automating some of this process, via an appropriate tool, can narrow down the number of resumes to look and, thus, result in a considerable savings of time and money.

Indeed, utterly lacking at present are tools for checking resumes for fraudulent information. There are, however, some arrangements available for extracting information such as skills and/or experience from resumes and matching such information with prospective employer's needs. For example, U.S. Patent Publication No. 2002/0046075 A1, “Certificate Matching”, describes a method for matching a candidate to a job based on matching requirements with qualifications.

There also exist companies that can verify an individual item on an individual resume for a price. For example, the PeopleBonus company (http://www.peoplebonus.com/PB/AboutUs.html) uses Statistical Natural Language Processing to extract resume data and convert it into XML: [http://]www.peoplebonus.com/PB/IntelligentResumeProcessing.Html. On the other hand, Trak It Solutions (http://www.trak-it.com) provides tools to extract information such as skills, experience and education from resumes and place it into a database. However, conventional tools such as these do not actually serve to verify information provided on a resume.

Comprehensive Information Services, Inc. (CIS) provides fraud detection service for a price; however, the service is performed solely on individual items, i.e., on an individual application basis. Such a service would clearly be very expensive to use in selecting from a large number of candidates.

Similarly, [http://]www.orionomi.com/index.htm utilizes investigators to verify information provided on a resume. Again, this service would not be appropriate in narrowing down a significant number of applications.

A manual process for investigating information provided on a resume is also described in U.S. Patent Publication No. 2004/0230478, “Method and System for Streamlining Recruitment Process Through Independent Certification of Resumes”, which deals with manual verification of individual resumes for selected previously screened candidates. This process is essentially inadequate for pre-screening multiple resumes for the purpose of selecting promising ones as well as identifying questions that could be asked. U.S. Patent Publication No. 2003/0171927 A1, “Method and System for Verifying or Certifying Traits of Candidates Seeking Employment”, describes a manual method for allowing individual job seekers to specify that they permit the verification of information and the usage of the results.

Some conventional arrangements also exist in the realm of creating databases containing resume information. For instance, U.S. Pat. No. 6,658,400, issued Dec. 2, 2003 (“Data Certification and Verification System Having a Multiple-User-Controlled Data Interface”), describes a repository where job applicants can enter resumes while the verification part is done by a verification services staff. U.S. Pat. No. 6,714,944, issued Mar. 30, 2004 (“System and Method for Authenticating and Registering Personal Background Data”), on the other hand, describes a method of structuring a database to provide access to verified data. While this patent includes a verification component and involves the sending of queries to other parties for verification, it uses structured database entries for verification wherein the information that needs to be verified is not determined (this is pre-defined in the database), nor is there described the correlation of information between components or the use of field-specific heuristics for verifying information or generating sample questions based on this information. U.S. Patent Publication No. 2004/0186852 A1, “Internet Based System of Employment Referencing and Employment History Verification for the Creation of a Human Capital Database”, also describes a method for creating and managing a database containing worker information. The method requires a prospective employer to enter the data from resumes—a time-consuming method that can only be done on very few strong candidates. U.S. Patent Publication No. 2004/0215623 A1, “Method and Apparatus for Sending and Tracking Resume Data Sent via URL”, describes a database for collecting resumes sent via URL and for selecting relevant candidates from the database and allowing access to stored information.

Clearly, a tool that can do preliminary verification and discard fraudulent applications, or at least flag suspicious ones, can result in significant savings of money for potential recruiters. The capability of such a tool to do a preliminary correlation between various components of a resume (such as, for example, between skills and experience and/or objective and education) and then flag any mismatches, would help to further narrow down the list of resumes that a recruiter would need to look at. Conceivably, conventional services could then be used in for only small pool of strong candidates and only to check the information that an automated tool flagged based on a predefined criteria. Accordingly, a need has been recognized in connection with providing a tool that indeed is capable of at least providing the preliminary verification just mentioned.

### SUMMARY OF THE INVENTION

There is broadly contemplated herein, in accordance with at least one presently preferred embodiment of the present invention, a system (or tool or web service) for automatically screening resumes and/or job/admission applications for false information as well as for specific factors that make a particular candidate non-suitable for a particular job or school. The tool can also be used to generate questions that could be asked of a specific candidate based on the information provided in the resume.

Such a tool may optionally include a database preconfigured with some of the information pertinent to a specific field/group of jobs. For example, a system that is to be used to verify an information for programming jobs can include a database that includes the list of most well-known universities as well as the lists of graduates organized by year. It can also optionally include the list of well-known companies hiring candidates with specific backgrounds, the contact e-mail and the information of the skills that could be utilized by each company in a given year. The system allows for manual as well as automated updates (e.g. live update from the service provider) of the database.

In summary, one aspect of the invention provides a system for automatically verifying job applicant information from an input document, said system comprising: an arrangement for rendering parseable job applicant information from the input form; and an arrangement for providing job applicant verification via at least one of: automatic fact-checking; and automatic reconciliation of at least one word or statement with at least one verifiable fact.

Another aspect of the invention provides a method of automatically verifying job applicant information from an input document, said method comprising the steps of: rendering parseable job applicant information from the input form; and providing job applicant verification via at least one of: automatic fact-checking; and automatic reconciliation of at least one word or statement with at least one verifiable fact.

Furthermore, an additional aspect of the invention provides a program storage device readable by machine, tangibly embodying a program of instructions executable by the machine to perform method steps for automatically verifying job applicant information from an input document, said method comprising the steps of: rendering parseable job applicant information from the input form; and providing job applicant verification via at least one of: automatic fact-checking; and automatic reconciliation of at least one word or statement with at least one verifiable fact.

For a better understanding of the present invention, together with other and further features and advantages thereof, reference is made to the following description, taken in conjunction with the accompanying drawings, and the scope of the invention will be pointed out in the appended claims.

### BRIEF DESCRIPTION OF THE DRAWINGS

FIG. 1 is a diagram of a networked data processing system in which the present invention may be implemented.

FIGS. 2A and 2B are logic flow diagrams showing the overall processing of each resume/application form by the system.

FIG. 3 is a logic flow diagram demonstrating flow of control in processing each verifiable component of a resume/application form.

### DESCRIPTION OF THE PREFERRED EMBODIMENTS

It will initially be noted that, in verifying factual information provided on a resume or application form, the present invention may preferably make use of a method as described in copending and commonly assigned U.S. Patent Publication No. 20040122846, entitled “System for verification of facts”, which is incorporated by reference as if set forth in its entirety herein. However, at least one embodiment of the present invention goes beyond a simple fact verification by adding the heuristic analysis of data and using domain-specific screening of applicants.

Resumes, job applications, or school applications, perhaps located on web sites, sent via e-mail or scanned from paper, may preferably be parsed whereby required or desired information is placed into a form using conventional tools. Some users may find it more advantageous to simply require all applicants to use a specific standard format of a resume or place the information into an easily parseable form. In other embodiments, resumes posted on job seeking web sites can be parsed, the information extracted and verified in order to narrow down the list of potential applicants. This can be achieved by connecting to a specific website, downloading HTML files containing resumes (or other forms), and parsing them. While this process may not be very accurate because of the inconsistent format of these postings, it could still be useful in narrowing down the choices.

Once the information is extracted, some main components of the information can preferably be verified as follows:

Education: The name of the university is checked against the list of accredited universities (in the US) as well as the lists of known legitimate institutes of higher learning in the applicant's country. In comparing the names of the universities, “wild card” comparison methods (an example of which would be a method for scanning for variants as used in anti-virus tools) are used to avoid the flagging of mere typographical errors as “fraudulent”. The information is first preferably checked against the locally maintained list of legitimate educational institutions of the countries likely to have graduates in a particular field as well as against a local list of obviously fraudulent ones. The list is dynamic and can be modified by the system's user or the web service' provider. If an educational institution is not found on a list the information is flagged as suspicious.

Once the existence and accreditation of a particular institution is verified, the name of the applicant is preferably checked against the names of alumni of the institution for the specified year, whereby the degree mentioned in the resume is verified. This information can either be maintained by the verification tool/service or obtained as necessary from the university itself. Obtaining the information from the university can be achieved by 1) checking the local database, 2) directly querying the database if supported by a particular institution, and/or 3) sending an e-mail to the institution using a contact address stored in local database and requesting the reply in a specific easily parseable form (such as, for example, a form that would ask to specify yes/no answers, e.g., “Did John Smith graduate from the university in 1995?” . . . Yes/No; “Did he graduate Magna Cum Laude?”, “Was he majoring in . . . ?”, etc.), and processing the received e-mail. The methods can thus be used in combination; for example, if a particular graduate is not found in a local database even though the database contains both the university name and the list of graduates, but the university claims he/she indeed graduated in a particular year, the information can be flagged for additional checking (whereby such checking could reveal whether someone hacked into a university computer).

In addition to specific checks, the application form can preferably be checked for vague information such as, for example, “State University, Chemistry” without mention of a specific degree earned. Depending on the user's preferences, the forms containing this type of information can be discarded or flagged. A locally maintained, customized list of known “suspicious” terms can preferably be utilized here.

Experience: The existence of every company mentioned in the resume during the years the applicant worked there, the company's address, and the telephone number of a company can preferably be checked. If the company provides an e-mail address, an automated request can preferably be sent to the company to determine if an applicant worked there during the specified years. A response may be requested in a provided easily-parseable form as described above. A heuristics can also be applied to experience verification by checking the consistency of dates, including unexplained gaps or overlaps in work experience. If a candidate has changed his/her job several times during a short period of time, the tool can highlight this fact. The comparison of dates in the education and employment sections can also indicate some fraudulent information.

For example, a list of dates, starting from the year of graduation, can be extracted and specific cases (such as “2004-1999” or “1990-1994”) can be flagged. As in the case with educational institutions, a local database of well-known companies with known addresses, contact e-mails, and years of operation can be maintained. This database can also include the list of most likely skills that are likely to be used in with each company. For example, a programmer with an experience working for Merrill Lynch is more likely to have experience in writing database applications than in developing database management systems whereas a software engineer working for Oracle is more likely to have experience in the latter. A company that doesn't have a website is unlikely to employ web developers. This information can be used in verifying skills; any mismatches can be flagged for later checking.

Certifications: If the applicant's resume lists certifications, an automated request is preferably sent to the certification providers to obtain the list of people who received certification on the date specified in the resume. The applicant's name is then checked against the list. Again, a company interested in a specific group of certifications can customize the tool's database to include the names of people who received the certification in a particular year. In some embodiments, such a tool can automatically query the appropriate organizations to obtain such a list for a specific year and to update its databases accordingly.

Skills: The criteria for recognizing false information are preferably job-specific. Examples of include: too many skills in different areas obtained in a very short period of time, n years of experience in a field that only existed for less than “n” years (e.g. “over 10 years of experience in Java or XML” given that these languages appeared less than 10 years ago). A particular company may update this list with the information pertinent to their specific field, so the lack or misuse of industry specific terminology may indicate a lack of credibility

Preliminary correlation between components: While the generic correlation between various components of a document is very difficult, in special cases/group of jobs, a simple correlation between, for example, skills and experience or objectives and education can be achieved. For example, a resume from an applicant listing chip-design in his/her list of skills, but working only for software companies, could be flagged for further investigation.

Additional verification (such as a board's disciplinary actions or a criminal record) can be obtained by querying a specific organization such as a police department or medical board. The process of querying the information is preferably similar to the one used for education (as described above). The resulting form will preferably include the type of the offense and the year. The offense can then be checked against a specific list of offenses that disqualify the applicant from doing a specific job. A simple example of such verification is a list of sex offenders. Another example would lie in querying a medical board for disciplinary actions taken against a physician or querying a physician's record for known surgeries results statistics.

In addition, in verification of both the education and experience, a list of universities or companies that were already found to be non-existent or fraudulent is preferably maintained and used during the verification process.

The resumes/applications that are found to be ‘definitely fraudulent’ can be rejected outright. If such a definitive determination is not possible, the resume may be placed in a special ‘unable to verify’ group with the non-verifiable information highlighted for further manual processing (if desired).

Questionable resumes may warrant “strategic interviews”. In accordance with an embodiment of the present invention, the tool can compile a list of questions for a candidate. For instance, if an expression such as “top seller” is used in a resume, the question, “How many people were involved in sales?”, can be compiled. If a resume states “processing orders and invoices”, a question asking to explain the step-by-step procedures and exact paperwork involved in this duty can be put in the list of suggested questions. Career progression can be easily tracked from the experience section and related questions can be selected for a candidate.

The usage of particular words (“fluent”, “conversational”, “and professional”) in the skill and experience sections can be used by the tool to create questions or set up flags.

Previous employment by some specific non-profit organizations, fund raising, lobbying or political bodies can be flagged by the tool (e.g., to help determine whether such activities might be appropriate in the context of a private company to which a candidate is applying).

An unusual combination of experiences, skills, and background can be traced to set an “alarm”. For example, “news reporter” and “fiction writer” or “ability to work off hours” and “being a part time graduate student” or “managing a team of construction workers” and “managing a team of sales people”. Though sometimes unusual experience can be beneficial, recruiters often look for consistency in experience. Consistency can be checked by verifying each and every experience for a set of key words.

In at least one embodiment of the present invention, a verification system may preferably provide an application programming interface (API) and a plug-in mechanism, to enable users or third-party suppliers to add verification methods to the system to suit particular needs or take advantage of particular information sources. For example without restriction, the API might provide functions that allow each verification plug-in to access both the raw and the parsed form of the resume or employment application, to perform arbitrary processing on that information, and then to produce output messages to be added to the program's output, including warnings of things that are likely to be false or needing of verification, or additional questions to be asked at a verification.

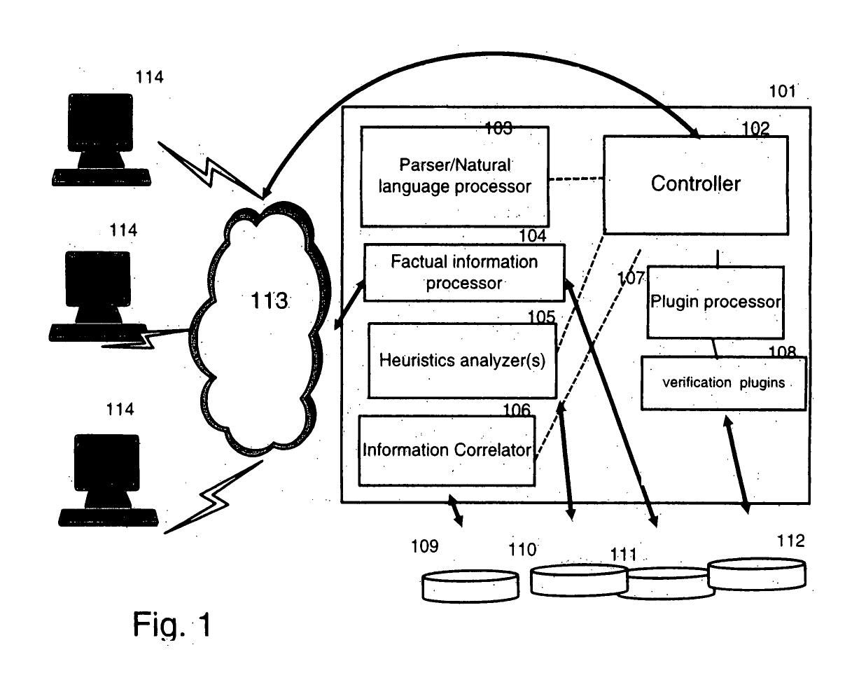

The preferred embodiment described above is outlined in attached drawings. FIG. 1 shows a preferred architecture of a system 101. The controller 102 is responsible for obtaining resumes, controlling the order of verification and generating final reports. It uses parser 103 for extracting information from a form or parsing resumes. One or more factual information processors 104 are responsible for verifying factual information contained in individual components such as university or company information as described above. Heuristic analyzer(s) 105 perform logical analysis of information such as for example date consistency or use of generic terms while the information correlator 106 verifies the information consistency across different components. Plugin processor 107 allows a user to provide verification plugins 108 for verifying domain-specific information. Factual information processor 104 utilizes both the local databases 111 and the remote databases 114 it connects to via internet 113. Heuristics analyzer 105 and information correlator 106 may optionally also utilize local databases 110 and 109 for relevant information.

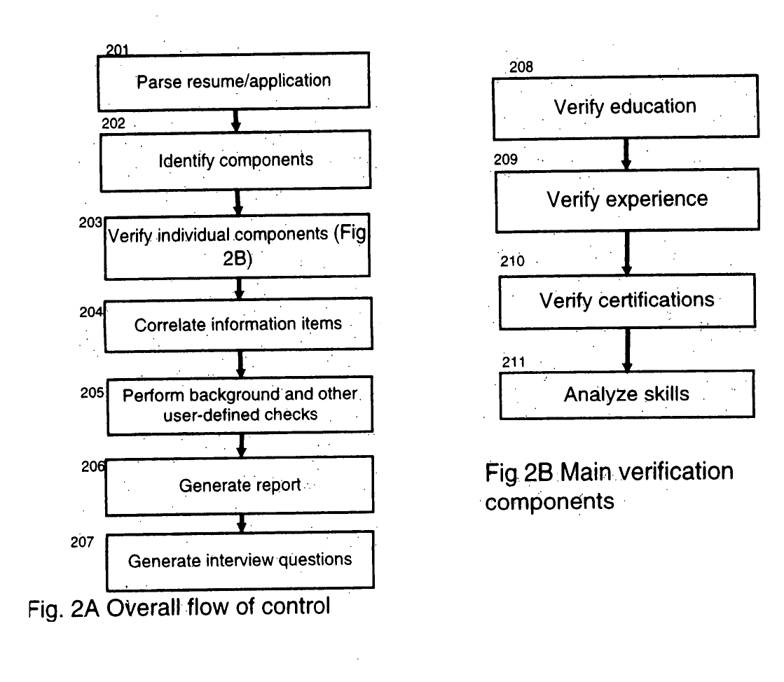

FIG. 2A summarizes the flow of control while processing individual resume/application form. After each resume is parsed (201), each of the components is identified (202) and verified (203). The information contained in different components is checked for consistency (204) and additional background as well as user-defined tests are performed 205. The report and interview questions are generated (206, 207) FIG. 2B outlines the main components verified in step 203—education (208), experience (209), certifications (210) and analyze skills (211).

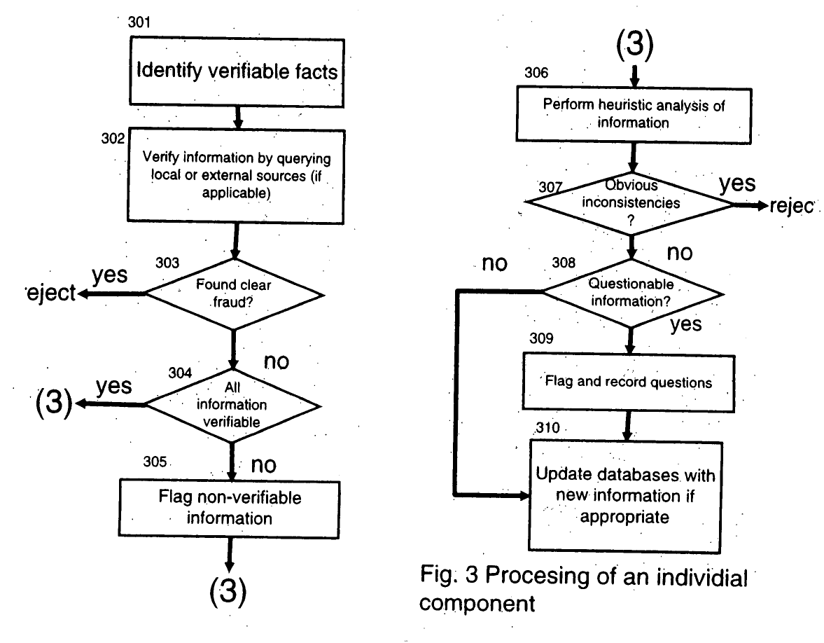

FIG. 3 illustrates the steps involved in processing of individual components such as education or experience. First, the facts that need to be verified are identified (301) and verified by querying the local database and/or the internet source. If a clear fraud is found (for example, the applicant never attended a specified university or worked for a specified or a university is a non-accredited institution) the application is rejected outright. If non-verifiable items are found (304), they are marked as such (305). The heuristics analysis is then performed (306) to detect inconsistencies such as unexplained time gaps or, if checking skills, impossible skills (10 years of experience in XML). If obvious inconsistencies or excessive number of inconsistencies are detected (307), the application is rejected; otherwise, any found questionable information (308, 309) is flagged. At the end, the databases may be updated with any new information (310). Note that specific criteria for rejection (for example, if and how many inconsistencies are acceptable) can be customized by the user.

By way of general recapitulation, there is broadly contemplated herein a system for automatically verifying information from an input form. Such a system may preferably include an arrangement for rendering parseable information from the input form, and an arrangement for providing verification via at least one of: automatic fact-checking, and automatic reconciliation of at least one word or statement with at least one verifiable fact.

The input form in question may include a resume or job application, which may be in paper or electronic form to begin with.

Preferably, verification can be provided with regard to at least one of the following items from an input form: educational background; work experience; a certification; one or more work-related skills; and legal status.

“Legal status”, as such, could include at least one of: citizenship status; security clearance status; and legal residency status.

In a particularly advantageous refinement of at least one embodiment of the present invention, verification of educational background can be provided via at least one of: verifying the existence and/or accreditation status of a specified school; verifying that an applicant graduated a specified school; and verifying that a specified degree was indeed conferred. Additionally or alternatively, verification of work experience can be provided via at least one of: verifying that any specified workplace exists; verifying that contact information provided for a workplace is valid; verifying that any specified workplace existed at a specified time; and verifying that an applicant worked at a workplace at a specified time. Furthermore, or alternatively, verification of one or more work-related skills can be provided via checking for discrepancies in one or more work-related skills based on industry-specific criteria.

Preferably, an arrangement can be provided for automatically querying an entity external to the system to verify information from the input form. Thus, by way of illustrative yet non-restrictive example, a university or workplace listed on a job application or resume could be automatically queried via the automatic sending of an email to such a university or workplace.

In one embodiment of the present invention, a system such as one broadly contemplated herein could be implemented as a web service.

In a particularly advantageous refinement of the present invention, an arrangement could be provided for automatically compiling at least one question for an applicant based on information parsed from the input form.

In at least one embodiment of the present invention, an interface arrangement could be provided for enabling an interface with one or more other arrangements for providing one or more supplementary automated verification processes. Thus, one may have the option of “plugging in” one or more supplementary verification processes or packages as such may become available, and/or as may be deemed of particular interest to an implementation at hand.

It is to be understood that the present invention, in accordance with at least one presently preferred embodiment, includes an arrangement for rendering parseable job applicant information and an arrangement for providing job applicant verification. Together, these elements may be implemented on at least one general-purpose computer running suitable software programs. These may also be implemented on at least one Integrated Circuit or part of at least one Integrated Circuit. Thus, it is to be understood that the invention may be implemented in hardware, software, or a combination of both.

If not otherwise stated herein, it is to be assumed that all patents, patent applications, patent publications and other publications (including web-based publications) mentioned and cited herein are hereby fully incorporated by reference herein as if set forth in their entirely herein.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

What is claimed is:

1. A system for automatically verifying job applicant information from an input document, said system comprising:
an arrangement for rendering parseable job applicant information from the input form; and
an arrangement for providing job applicant verification via at least one of:
automatic fact-checking; and
automatic reconciliation of at least one word or statement with at least one verifiable fact.

2. The system according to claim 1, wherein said arrangement for providing verification is adapted to correlate at least one word or statement with at least one other word or statement

3. The system according to claim 1, wherein said arrangement for providing verification is adapted to provide verification of at least one of the following items from an input form: educational background; work experience; a certification; one or more work-related skills; and legal status.

4. The system according to claim 3, wherein legal status includes at least one of: citizenship status; security clearance status; and legal residency status.

5. The system according to claim 3, wherein said arrangement for providing verification is adapted to provide at least one of:
verification of educational background via at least one of:
verifying the existence and/or accreditation status of a specified school;
verifying that an applicant graduated a specified school; and
verifying that a specified degree was indeed conferred;
verification of work experience via at least one of:
verifying that any specified workplace exists;
verifying that contact information provided for a workplace is valid;
verifying that any specified workplace existed at a specified time; and
verifying that an applicant worked at a workplace at a specified time; and
verification of one or more work-related skills via checking for discrepancies in one or more work-related skills based on industry-specific criteria.

6. The system according to claim 1, further comprising an arrangement for automatically querying an entity external to the system to verify information from the input form.

7. The system according to claim 1, wherein said system is implemented as a web service.

8. The system according to claim 1, further comprising an arrangement for automatically compiling at least one question for an applicant based on information parsed from the input form.

9. The system according to claim 1, further comprising an interface arrangement for enabling an interface with one or more other arrangements for providing one or more supplementary automated verification processes.

10. A method of automatically verifying job applicant information from an input document, said method comprising the steps of:
rendering parseable job applicant information from the input form; and
providing job applicant verification via at least one of:
automatic fact-checking; and
automatic reconciliation of at least one word or statement with at least one verifiable fact.

11. The method according to claim 1, wherein said step of providing verification comprises correlating at least one word or statement with at least one other word or statement

12. The method according to claim 1, wherein said step of providing verification comprises providing verification of at least one of the following items from an input form: educational background; work experience; a certification; one or more work-related skills; and legal status.

13. The method according to claim 3, wherein legal status includes at least one of: citizenship status; security clearance status; and legal residency status.

14. The method according to claim 3, wherein said step of providing verification comprises providing at least one of:
verification of educational background via at least one of:
verifying the existence and/or accreditation status of a specified school;
verifying that an applicant graduated a specified school; and
verifying that a specified degree was indeed conferred;
verification of work experience via at least one of:
verifying that any specified workplace exists;
verifying that contact information provided for a workplace is valid;
verifying that any specified workplace existed at a specified time; and
verifying that an applicant worked at a workplace at a specified time; and
verification of one or more work-related skills via checking for discrepancies in one or more work-related skills based on industry-specific criteria.

15. The method according to claim 1, further comprising the step of automatically querying an entity external to the system to verify information from the input form.

16. The method according to claim 1, wherein said method is performed in conjunction with a web service.

17. The method according to claim 1, further comprising the step of automatically compiling at least one question for an applicant based on information parsed from the input form.

18. The method according to claim 1, further comprising the step of enabling an interface with one or more other arrangements for providing one or more supplementary automated verification processes.

19. A program storage device readable by machine, tangibly embodying a program of instructions executable by the machine to perform method steps for automatically verifying job applicant information from an input document, said method comprising the steps of:
rendering parseable job applicant information from the input form; and
providing job applicant verification via at least one of:
automatic fact-checking; and
automatic reconciliation of at least one word or statement with at least one verifiable fact.
